(19) United States
(12) Patent Application Publication
(10) Pub. No.: US 2025/0187996 A1
(43) Pub. Date: Jun. 12, 2025

(54) MICROBE-ENHANCED FERTILIZERS

(71) Applicant: SABIC AGRI-NUTRIENTS COMPANY, Riyadh (SA)

(72) Inventors: Mohamed AL RABHI, Sugar Land, TX (US); Radwan ABDALLAH, Riyadh (SA); Meghna MARKANDAY, Bangalore (IN)

(73) Assignee: SABIC AGRI-NUTRIENTS COMPANY, Riyadh (SA)

(21) Appl. No.: 18/875,332

(22) PCT Filed: Jun. 22, 2023
(86) PCT No.: PCT/IB2023/056470

§ 371 Date: Dec. 16, 2024

(30) Foreign Application Priority Data
Jun. 22, 2022 (IN) 202211035828

(51) Int. Cl. C05F 11/08; C05G 5/12; C05G 5/35

(52) U.S. Cl. CPC C05F 11/08; C05G 5/12; C05G 5/35

(57) ABSTRACT

Disclosed herein are methods for the production of microbe-enhanced fertilizers. In certain embodiments, creation of microbe-enhanced fertilizers comprises incorporation of conditioned and/or otherwise protected microorganisms prior to and/or during the fertilizer granulation process. In some embodiments, compositions disclosed herein and/or produced through methods described herein are more economical, have better shelf-life, and/or improved bioavailability relative to otherwise comparable fertilizers comprising microorganism.

### CROSS-REFERENCE TO RELATED APPLICATIONS

This application claims priority to and the benefit of Indian Application No. 202211035828, filed Jun. 22, 2022, the contents of which are incorporated into the present application by reference.

### BACKGROUND

### A. Field of the Invention

The invention generally concerns methods of making microbe-enhanced fertilizers and compositions comprising the same, wherein the microbe-enhanced fertilizer comprises at least one fertilizer and at least one microorganism.

### B. Description of Related Art

Soil nutrients, such as nitrogen, phosphorus, potassium, and sulfur, as well as trace elements such as iron, zinc, copper, and magnesium, are useful for achieving thriving agriculture and growth of plants. Upon repeated planting cycles, the quantity of these nutrients in the soil may be depleted, resulting in reduced plant growth and decreased production. To counter this effect, fertilizers have been developed to help replace the depleted vital nutrients. Single-nutrient fertilizers and multi-nutrient fertilizers, such as fertilizer blends, have been developed to meet the varied needs of crop production worldwide.

Soil does not comprise just nutrients, it also comprises mineral substances, organic matter, and microorganisms. The role and activities of microorganisms in the soil microecological area is important for nutrient uptake by plants (e.g., via the root system), as beneficial microorganisms in the soil can directly participate in formation of soil fertility, e.g., conversion of substances and energy in the soil, formation and decomposition of humus and/or other organic material, release and/or fixation of trace elements and/or nutrients, fixation of nitrogen, etc.

However, in a purely natural state, the quantity of beneficial microorganisms in the soil may decrease and/or be insufficient for the agricultural yields anticipated by modern agrarian methods. Therefore, similar to the replenishment of soil using fertilizers comprising nutrients, soil may also need to be replenished with beneficial microorganisms.

Currently, most supplemental microorganisms are delivered to the soil for end use either: (i) directly in their commercial form (e.g., as a solid and/or liquid form fertilizer), (ii) in solution with irrigation water, (iii) coated to seeds under ambient temperature conditions, or (iv) coated to fertilizers under ambient temperature conditions. These delivery methods are limited in scope and also limit the type of microorganisms that can be utilized. There exists a need in the field to be able to widen the scope of microorganisms used and/or widen the scope of microorganism delivery methods when utilized in combination with various fertilizers. Some fertilizers, especially those highly acidic or basic, can be harmful to microorganisms by contact. In addition, high temperatures associated with fertilizer creation can render most microorganisms inactive and/or inefficient.

### SUMMARY

A discovery has been made that provides a solution to at least some of the problems associated with production, characteristics of, and/or use of combination fertilizers comprising fertilizer and microorganisms. In particular, disclosed herein are microbe-enhanced fertilizers comprising beneficial microorganisms and fertilizer, wherein the microorganisms are protected from heat and/or chemical exposure to an extent that renders them suitable for addition to the fertilizer during and/or before the granulation process while maintaining microorganism efficacy. Unlike many other approaches, disclosed herein are compositions and methods wherein microorganisms can be incorporated as part of the fertilizer particles, and can be included during the manufacture of the fertilizer. The ability to add the beneficial microorganisms and fertilizer during and/or before granulation, when temperature of the process can be over 60° C., and over 130° C. in some instances, simplifies the production requirements, can decrease costs, and can produce a fertilizer with beneficial microorganisms homogeneously dispersed through the fertilizer. Further the microbe-enhanced fertilizer composition enables delivery of stable microorganisms along with each granule of fertilizer, where the microorganism is needed and/or over time as the fertilizer degrades. Additionally, the microbe-enhanced fertilizer composition can have an increased microorganism and/or fertilizer shelf-life.

In some embodiments, provided herein are methods of making a microbe-enhanced fertilizer composition. The method may comprise: combining a protected microorganism with a fertilizer prior to and/or during fertilizer granulation to obtain the composition. In some instances, the protected microorganism contacts the fertilizer when the fertilizer has a temperature greater than 60° C. In some embodiments, the temperature is 60 to 160° C. In some embodiments, the temperature is 80 to 100° C. In some embodiments, the temperature is at or between 60, 65, 70, 75, 80, 85, 90, 95, 100, 105, 110, 115, 120, 125, 130, 135, 140, 145, 150, 155, or 160° C. In some embodiments, the microbe-enhanced fertilizer is further cooled to a temperature below 60° C. In some embodiments the temperature is at or above 60° C. for at or between 10, 11, 12, 13, 14, 15, 16, 17, 18, 19, 20, 25, 30, 35, 40, 45, 50, 55, 60, 70, 80, 90, 100, 110, or 120 minutes.

In some embodiments, the protected microorganism is homogenously mixed into the fertilizer. In some embodiments, the protected microorganism is combined with the fertilizer with a dosing pump or with spray drying equipment.

In some embodiments, the fertilizer comprises one or more granular fertilizer, preferably one or more of urea, diammonium phosphate, potassium sulfate, and/or a nitrogen phosphorus potassium (NPK) mix. In some embodiments, the fertilizer comprises urea.

In some embodiments, fertilizer granulation comprises chemically reacting reactants to form the fertilizer in a solution, forming a fertilizer melt from the solution, solidifying the fertilizer melt, and/or granulating the solidified fertilizer melt, wherein the protected microorganism is contacted with the fertilizer before and/or during granulation.

In some embodiments, the protected microorganism is protected by addition of one or more physical protectants and/or by engineering methods (e.g., spray drying, freeze-drying, etc.). In some instances, the microorganism is protected by an encapsulating agent, water-soluble additive (e.g., water-soluble protectants and/or water-soluble humectants), stabilizer additive, and/or a dispersant. In some embodiments, the protected microorganism is encapsulated with a stabilizer. In some embodiments, the stabilizer comprises one or more of clay, diatomaceous earth, starch, agar, alginate, chitosan, PEG, PVA, -polyacrylic acid, ethanol, humic acid, humates, talc, clay, peat, lignite, vermiculite, perlite and/or chemically modified versions of the same. In some embodiments, wherein the stabilizer is chemically modified, the chemical modification comprises one or more of esterification, alkylation, acctylation, phosphorylation, hydrophobic modification, sulfation, sulfomethylation, methylation, amidation, amination, protonation, halogenation, nitration, copolymerization, and/or physical or covalent cross-linking. In some embodiments, the stabilizer comprises calcium alginate and/or sodium alginate. In some embodiments, the water-soluble additive (e.g., water-soluble protectants and/or water-soluble humectants) comprises glycerol, carboxy methyl cellulose (CMC), polyvinyl pyrrolidone (PVP), gum Arabic, guar gum, and/or mono and/or disaccharide based CMC/Arabic gum/guar gum. In some embodiments, the protected microorganism is contacted with a physical protectant, such as a encapsulating agent, water-soluble additive, stabilizer additive, and/or a dispersant. In some embodiments, the physical protectant is a molecule and/or enzyme derived from a thermophilic organism. In some embodiments, the physical protectant is diglycerol phosphate. In some embodiments, the protected microorganism is protected by an engineering method. In some embodiments, the engineering method comprises spray drying and/or freeze-drying.

In some embodiments, the protected microorganism comprises a spore/cyst forming bacteria. In some embodiments, the protected microorganism is comprised in a plurality of protected microorganisms and greater than, equal to, or any range therein of 50, 60, 70, 80, or 90% of the plurality of microorganisms are comprised in a spore or a cyst. In some embodiments, the microorganism protected has not been chemically induced to form spores/cysts. In some embodiments, the protected microorganism has not been selected for heat tolerance. In some embodiments, the protected microorganism, when contacted with the fertilizer is not a chemically induced spore or cyst. In some embodiments, the protected microorganism comprises diazotrophic bacteria, Azospirillum species, Azotobacter species, Frateuria aurantia, Bacillus species, endophytes, nitrogen fixing bacteria, methylotrophs, comammox, phosphorus solubilizing, nitrite oxidizing, Nitrospira species, Methylobacterium species, and/or pink pigmented facultative methylotrophs (PPFM-trophs). In some embodiments, a plurality of the protected microorganism is combined at a concentration of 10⁴-10¹² cells per gram of the fertilizer. In some embodiments, a plurality of the protected microorganism is combined at a concentration of 10⁸-10⁹ cells per gram of the fertilizer.

In some embodiments, provided herein is a microbe-enhanced fertilizer produced by any of the methods described herein. In some embodiments, the microbe-enhanced fertilizer is a powder, prill, and/or granule. In some embodiments, the microbe-enhanced fertilizer is configured to have a longer fertilizer and/or microbe shelf-life relative to an otherwise comparable microbe-enhanced fertilizer wherein the microorganism is combined without being protected. In some embodiments, the microbe-enhanced fertilizer is configured to have a greater bioavailability relative to an otherwise comparable microbe-enhanced fertilizer wherein the microorganism is combined without being protected.

In some embodiments, provided herein is a microbe-enhanced fertilizer composition comprising: a microorganism configured to be protected for at least, at, or between 10, 11, 12, 13, 14, 15, 16, 17, 18, 19, 20, 25, 30, 35, 40, 45, 50, 55, 60, 70, 80, 90, 100, 110, or 120 minutes when exposed to temperatures between 60 and 160° C., such as or between 60, 65, 70, 75, 80, 85, 90, 95, 100, 105, 110, 115, 120, 125, 130, 135, 140, 145, 150, 155, or 160° C. In some embodiments, a microbe-enhanced fertilizer composition comprises a plurality of microorganisms configured to be protected from having over 1, 2, 3, 4, 5, 6, 7, 8, 9, 10, 20, 30, 40, 50, 60, 70, 80, or 90% of the plurality of microorganisms being killed when exposed to temperatures such as or between 60, 65, 70, 75, 80, 85, 90, 95, 100, 105, 110, 115, 120, 125, 130, 135, 140, 145, 150, 155, or 160° C., for at least, at, or between 10, 11, 12, 13, 14, 15, 16, 17, 18, 19, 20, 25, 30, 35, 40, 45, 50, 55, 60, 70, 80, 90, 100, 110, or 120 minutes. In some embodiments, a fertilizer contacts the protected microorganism. In some embodiments, the protected microorganism is at least partially surrounded by the fertilizer. In some embodiments, the microorganism is not comprised in a spore or a cyst. In some embodiments, the protected microorganism is comprised in a plurality of protected microorganisms and greater than, equal to, or a percentage therein of 50, 60, 70, 80, or 90% of the plurality of microorganisms are comprised in a spore or a cyst. In some embodiments, the microorganism comprises a spore/cyst forming bacteria. In some embodiments, the microorganism has not been selected for heat tolerance within about 0.5, 1, 2, 3, 4, 5, or greater than 5 weeks of being contacted with the fertilizer. In some embodiments, the fertilizer is a solidified fertilizer melt. In some embodiments, the fertilizer contacting the protected microorganism is a solidified fertilizer melt that at least partially coats the protected microorganism. In some embodiments, the solidified fertilizer melt is in the form of a continuous matrix that encapsulates the protected microorganism. In some embodiments, the fertilizer comprises one or more granular fertilizer, preferably one or more of urea, diammonium phosphate, potassium sulfate, and/or a nitrogen phosphorus potassium (NPK) mix.

In some embodiments, a microbe-enhanced fertilizer can comprise any granulatable fertilizer. In some embodiments, the microbe-enhanced fertilizer may contain a nitrogen based fertilizer, a phosphate-based fertilizer, a potassium-based fertilizer, a urea-based fertilizer, a fertilizer providing nitrogen-phosphorus-potassium (NPK), a diammonium phosphate (DAP), monoammonium phosphate (MAP), single superphosphate (SSP), triple superphosphate (TSP), urea, potassium chloride, potassium sulfate, magnesium sulfate, superphosphates, rock phosphate, potash, sulfate of potash (SOP), muriate of potash (MOP), a biowaste material, char, ashes from incineration of animal waste or animal tissues, or any combination thereof.

In some aspects, forming the microbe-enhanced fertilizer may include addition of a protected microorganism, a fertilizer, and/or one or more additives (e.g., urea, calcium sulfate, phosphogypsum, water, etc.) into a fertilizer melt, a solidifying fertilizer melt, and/or a solid fertilizer.

In some embodiments, a microbe-enhanced fertilizer comprises an additive. The additive can be a micronutrient, a secondary nutrient, or an organic agent, etc. In some instances, the additive can be kieserite, carnallite, magnesite, dolomite, boric acid, boron (B), copper (Cu), iron (Fe), manganese (Mn), molybdenum (Mo), zinc (Zn), selenium (Se), silicon (Si), free Ca, magnesium (Mg), elemental sulfur (S), neem oil, seaweed extract, bio-stimulants, inhibitors of urea hydrolysis and/or nitrification, agents to slow or increase the rate of degradation of the granule, agents to repel moisture and/or provide a hydrophobic layer, agents that decrease or increase the reactivity of the granule, agents that provide additional benefits to plants, agents that increase the stability and/or crush strength of the granule, pH buffering agents, drying agents, etc. or any combination thereof.

In some embodiments, the microbe-enhanced fertilizer composition can include a coating on the surface of the fertilizer granule and/or the process of forming the microbe-enhanced fertilizer composition can include adding a coating on the surface of the microbe-enhanced fertilizer granules. In some instances, the coating can contain nutrients for a plant, inhibitors of urea hydrolysis and/or nitrification, agents to slow or increase the rate of degradation of the granule, agents to repel moisture and/or provide a hydrophobic layer, agents that decrease or increase the reactivity of the granule, agents that provide additional benefits to plants, agents that increase the stability and/or crush strength of the granule, pH buffering agents, drying agents, etc. or any combination thereof. Non-limiting examples of a coating include a commercially available coating, an oil, a fertilizer, a micronutrient, talc, a seaweed and/or seaweed extract, a wax, etc. In some instances, the coating can contain surfactants. In some instances, the coating contains a wax, surfactants, and/or an amine-based compound. The coating can be applied to the granule before drying, during drying of the granule, or after drying of the granule. The coating can be applied to the granule by spraying, pouring, mixing, blending, etc. A fluid bed sprayer or coater, a liquid spray mixer, a rotating drum or pan, spray coating at discharge point, a paddle mixer, etc. can be used.

In some instances, the microbe-enhanced fertilizer composition can have a density greater than water (e.g., greater than 1.0 g/mL). In some instances, the microbe-enhanced fertilizer composition can be comprised of one or more particles. In some embodiments, the microbe-enhanced fertilizer composition of the present invention can have an average particle size of 1 millimeter (mm) to 5 mm, preferable about 2 mm to 4 mm.

Also disclosed in the context of the present invention are blended or compounded fertilizer compositions that include a plurality of microbe-enhanced fertilizer compositions disclosed herein mixed with other fertilizers, micronutrients, secondary nutrients, or organic agents. The other fertilizers can be particulate in form (e.g., urea, monoammonium phosphate (MAP), diammonium phosphate (DAP), muriate of potash (MOP), and/or sulfate of potash (SOP)). The microbe-enhanced fertilizers and other fertilizers, micronutrients, secondary nutrients, or organic agents can be compatible with each other (e.g., can contact each other without having a chemical reaction take place). The blended or compounded fertilizer can contain, in addition to the microbe-enhanced fertilizer composition, a nitrogen based fertilizer, a phosphate-based fertilizer, a potassium-based fertilizer, a urea-based fertilizer, a fertilizer providing nitrogen, phosphorus, and potassium (NPK), diammonium phosphate (DAP), monoammonium phosphate (MAP), single superphosphate (SSP), triple superphosphate (TSP), urea, potassium chloride, potassium sulfate, magnesium sulfate, superphosphates, rock phosphate, potash, sulfate of potash (SOP), muriate of potash (MOP), kieserite, carnallite, magnesite, dolomite, boric acid, B, Cu, Fe, Mn, Mo, Zn, Se, Si, Ca, Mg, S, neem oil, seaweed extract, bio-stimulants, biowaste, char, ashes from incineration of animal waste or animal tissues, etc., or any combination thereof.

In some embodiments of the present invention, methods of fertilizing are described. A method can include applying a plurality of a microbe-enhanced fertilizer composition, and/or blended or compounded fertilizer compositions described herein to a portion of a soil, a crop, or a combination of the soil and the crop. In some embodiments, the soil is at least partially or fully submerged under water (e.g., rice paddy crops) and the granules sink in the water to contact the soil.

Certain embodiments of the present invention are characterized through the following aspects.

Aspect 1 is a method of making a microbe-enhanced fertilizer composition, the method comprising: combining a protected microorganism with a fertilizer prior to and/or during fertilizer granulation to obtain the composition, wherein the protected microorganism contacts the fertilizer when the fertilizer has a temperature greater than 60° C.

Aspect 2 is the method of aspect 1, wherein the temperature is 60 to 160° C., preferably 80 to 100° C.

Aspect 3 is the method of any one of aspects 1 or 2, wherein the protected microorganism is homogenously mixed into the fertilizer.

Aspect 4 is the method of any one of aspects 1-3, wherein the protected microorganism is combined with the fertilizer with a dosing pump or with spray drying equipment.

Aspect 5 is the method of any one of aspects 1-4, further comprising cooling the obtained composition to a temperature below 60° C.

Aspect 6 is the method of any one of aspects 1-5, wherein the fertilizer comprises one or more granular fertilizer, preferably one or more of urea, diammonium phosphate, potassium sulfate, and/or a nitrogen phosphorus potassium (NPK) mix.

Aspect 7 is the method of any one of aspects 1-6, wherein the fertilizer comprises urea.

Aspect 8 is the method of any one of aspects 1-7, wherein fertilizer granulation comprises chemically reacting reactants to form the fertilizer in a solution, forming a fertilizer melt from the solution, solidifying the fertilizer melt, and granulating the solidified fertilizer melt, and wherein the protected microorganism is contacted with the fertilizer before or during granulation.

Aspect 9 is the method of any one of aspects 1-8, wherein the protected microorganism is protected by addition of one or more physical protectants, engineering methods, encapsulating agents, water-soluble additives, stabilizer additives, and/or dispersants.

Aspect 10 is the method of any one of aspects 1-9, wherein the protected microorganism is encapsulated with a stabilizer.

Aspect 11 is the method of aspect 10, wherein the stabilizer comprises one or more of clay, diatomaceous earth, starch, agar, alginate, chitosan, PEG, PVA, -polyacrylic acid, ethanol, humic acid, humates, talc, clay, peat, lignite, vermiculite, perlite and/or chemically modified versions of the same.

Aspect 12 is the method of aspect 11, wherein the chemical modification comprises one or more of esterification, alkylation, acetylation, phosphorylation, hydrophobic modification, sulfation, sulfomethylation, methylation, amidation, amination, protonation, halogenation, nitration, copolymerization, and/or physical or covalent cross-linking.

Aspect 13 is the method of any one of aspects 9-12, wherein the stabilizer comprises calcium alginate and/or sodium alginate.

Aspect 14 is the method of any one of aspects 9-13, wherein the water-soluble additive comprises glycerol, carboxy methyl cellulose (CMC), polyvinyl pyrrolidone (PVP), gum Arabic, guar gum, and/or mono and/or disaccharide based CMC/Arabic gum/guar gum.

Aspect 15 is the method of any one of aspects 1-14, wherein the protected microorganism is contacted with a physical protectant.

Aspect 16 is the method of aspect 15, wherein the physical protectant is a molecule and/or enzyme derived from a thermophilic organism.

Aspect 17 is the method of aspect 15 or 16, wherein the physical protectant is diglycerol phosphate.

Aspect 18 is the method of any one of aspects 1-17, wherein the protected microorganism is protected by an engineering method.

Aspect 19 is the method of aspect 18, wherein the engineering method comprises spray drying, and/or freeze-drying.

Aspect 20 is the method of any one of aspects 1-19, wherein the protected microorganism comprises a spore/cyst forming bacteria.

Aspect 21 is the method of any one of aspects 1-20, wherein the microorganism protected has not been chemically induced to form spores/cysts.

Aspect 22 is the method of any one of aspects 1-21, wherein the protected microorganism has not been selected for heat tolerance.

Aspect 23 is the method of any one of aspects 1-22, wherein the protected microorganism is not comprised in a chemically induced spore or cyst when contacted with the fertilizer.

Aspect 24 is the method of any one of aspects 1-23, wherein the protected microorganism comprises diazotrophic bacteria. Azospirillum species, Azotobacter species, Frateuria aurantia, Bacillus species, endophytes, nitrogen fixing bacteria, methylotrophs, comammox, phosphorus solubilizing, nitrite oxidizing, Nitrospira species, Methylobacterium species, and/or pink pigmented facultative methylotrophs (PPFM-trophs).

Aspect 25 is the method of any one of aspects 1-24, wherein a plurality of the protected microorganism is combined at a concentration of 10⁴-10¹² cells per gram of the fertilizer, preferably 10⁸-10⁹ cells per gram of the fertilizer.

Aspect 26 is a microbe-enhanced fertilizer produced by the method of any one of aspects 1-25.

Aspect 27 is the microbe-enhanced fertilizer of aspect 26, wherein the microbe-enhanced fertilizer is a powder, prill, and/or granule.

Aspect 28 is the microbe-enhanced fertilizer of aspect 26 or 27, wherein the microbe-enhanced fertilizer is configured to have a longer fertilizer and/or microbe shelf-life relative to an otherwise comparable microbe-enhanced fertilizer wherein the microorganism is combined without being protected.

Aspect 29 is the microbe-enhanced fertilizer of any one of aspects 26-28, wherein the microbe-enhanced fertilizer is configured to have a greater bioavailability relative to an otherwise comparable microbe-enhanced fertilizer wherein the microorganism is combined without being protected.

Aspect 30 is a microbe-enhanced fertilizer composition comprising: a plurality of microorganisms configured to be protected from having over 50% of the plurality of microorganisms being killed when exposed to temperatures between 60 and 160° C. for at least 10 minutes; and a fertilizer contacting the protected microorganism, wherein the protected microorganism is at least partially surrounded by the fertilizer.

Aspect 31 is the microbe-enhanced fertilizer composition of aspect 30, wherein at least 90% of the plurality of microorganisms are not comprised in a spore or a cyst.

Aspect 32 is the microbe-enhanced fertilizer composition of any one of aspects 30 to 31, wherein the plurality of microorganisms comprise a spore/cyst forming bacteria.

Aspect 33 is the microbe-enhanced fertilizer composition of any one of aspects 30-32, wherein the plurality of microorganisms have not been selected for heat tolerance within 1 week of being contacted with the fertilizer.

Aspect 34 is the microbe-enhanced fertilizer composition of any one of aspects 30-33, wherein the fertilizer is a solidified fertilizer melt.

Aspect 35 is the microbe-enhanced fertilizer composition of aspect 34, wherein the fertilizer contacting the protected plurality of microorganisms is a solidified fertilizer melt that at least partially coats the protected plurality of microorganisms.

Aspect 36 is the microbe-enhanced fertilizer composition of any one of aspects 34 or 35, wherein solidified fertilizer melt is in the form of a continuous matrix that encapsulates the protected plurality of microorganisms.

Aspect 37 is the microbe-enhanced fertilizer composition of any one of aspects 30-36, wherein the fertilizer comprises one or more granular fertilizer, preferably one or more of urea, diammonium phosphate, potassium sulfate, and/or a nitrogen phosphorus potassium (NPK) mix.

The following includes definitions of various terms and phrases used throughout this specification.

The term “fertilizer” is defined as a material applied to soils or to plant tissues to supply one or more plant nutrients essential or beneficial to the growth of plants and/or stimulants or enhancers to increase or enhance plant growth. Non-limiting examples of fertilizers include materials having one or more of urea, ammonium nitrate, calcium ammonium nitrate, urea calcium sulfate adduct, one or more superphosphates, binary NP fertilizers, binary NK fertilizers, binary PK fertilizers, NPK fertilizers, molybdenum, zinc, copper, boron, cobalt, and/or iron. In some embodiments, fertilizers include agents that enhance plant growth and/or enhance the ability for a plant to receive the benefit of a fertilizer, such as, but not limited to biostimulants, urease inhibitors, and nitrification inhibitors.

The term “microbe” or “microorganism” can include bacteria, fungi, protists, and/or archaea.

The term “micronutrient” is defined as a chemical element or substance used in trace amounts for the normal growth and development of a plant. Non-limiting examples of micronutrients include B, Cu, Fe, Mn, Mo, Zn, Se, and Si or compounds thereof.

The term “secondary nutrient” is defined as a chemical element or substance used in moderate amounts for plant growth and are less likely to limit crop growth in comparison to N, P, and K. Non-limiting examples of secondary nutrients include Ca, Mg, and S.

The term “organic agent” is defined as a substance that is produced by or part of an organism. Non-limiting examples of organic agents suitable for a fertilizer include neem oil, seaweed extract, bio-stimulants, char, biowaste, ashes from incineration of animal waste or animal tissues, and diatomaceous earth.

The term “granule” can include a solid material. A granule can have a variety of different shapes, non-limiting examples of which include a spherical, a puck, an oval, a rod, an oblong, or a random shape.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The microbe-enhanced fertilizer composition and methods of producing the microbe-enhanced fertilizer composition of the present invention can “comprise,” “consist essentially of,” or “consist of” particular ingredients, components, compositions, steps, etc. disclosed throughout the specification. With respect to the transitional phase “consisting essentially of,” in one non-limiting aspect, a basic characteristic of the microbe-enhanced fertilizer of the present invention is the presence of a granulated fertilizer and a protected microorganism.

### BRIEF DESCRIPTION OF THE DRAWINGS

Advantages of the present invention may become apparent to those skilled in the art with the benefit of the following detailed description and upon reference to the accompanying drawings.

FIG. 1 depicts an exemplary microbe-enhanced fertilizer production method.

FIG. 2 depicts an exemplary protected microorganism protection scheme for production of protected microbes for inclusion in microbe-enhanced fertilizers.

FIG. 3 depicts an exemplary microbe-enhanced fertilizer.

While the invention is susceptible to various modifications and alternative forms, specific embodiments thereof are shown by way of example in the drawings. The drawings may not be to scale.

### DETAILED DESCRIPTION

Disclosed herein, among other things, is a method of producing a microbe-enhanced fertilizer and microbe-enhanced fertilizers. Currently, most combination fertilizers comprising a microorganism are produced by addition of the microorganisms directly to a completed fertilizer/soil mix, into a solution with irrigation water, onto a seed under temperatures well below 60° C. conditions, and/or as a coating to fertilizers at temperatures well below 60° C. The ability to add the beneficial microorganisms and fertilizer during and/or before granulation, when temperature of the process can be over 60° C., and over 130° C. in some instances, simplifies the production requirements, can decrease costs, and can produce a fertilizer with beneficial microorganisms homogeneously dispersed through the fertilizer. Further the microbe-enhanced fertilizer composition enables delivery of stable microorganisms along with each granule of fertilizer, where the microorganism is needed and/or over time as the fertilizer degrades. Additionally, the microbe-enhanced fertilizer composition can have an increased microorganism and/or fertilizer shelf-life.

In general, it is thought that exposing microorganisms to high temperatures can significantly reduce the microorganisms survival, viability, and/or effectiveness in storage and/or field use. However, herein, among other things, is described a process by which microorganisms can be conditioned and/or otherwise protected from the extremes of heat and/or chemical exposure. In some embodiments, such conditioning and/or protection can be exploited to improve and/or simplify a microbe-enhanced fertilizer creation processes, for example, by facilitating addition of living, viable, and/or otherwise effective microorganisms to fertilizers at high temperatures (e.g., temperatures greater than or equal to 60° C.). In some embodiments, methods described herein can improve the percentage of living microorganisms, percentage of viable microorganisms, and/or effectiveness of microorganisms comprised in a microbe-enhanced fertilizer when compared to combination fertilizers comprising microorganisms produced through traditional means.

The methods and/or compositions of the current disclosure provide an economically efficient means to produce and/or utilize a stable and high quality microbe-enhanced fertilizer. These and other non-limiting aspects of the present invention are discussed in further detail in the following sections.

### A. Types of Microorganisms Suitable for Microbe-Enhanced Fertilizers

In some embodiments, a microorganism that can be protected and included in a microbe-enhanced fertilizer can be a bacteria, archaea, fungi, or a protist. In some instances, the microorganism can include an endophyte, rhizosphere microbe, and/or phyllosphere microbe. In some embodiments, the microorganism can included more than one species of microorganism. In some embodiments, more than one species, genus, phylum, class, and/or kingdom can be represented in a group of microorganisms protected and/or included in a microbe-enhanced fertilizer.

In some embodiments, a protected microorganism can be, but is not limited to, a diazotrophic bacteria, Azospirillum species, Azotobacter species, Frateuria aurantia, Bacillus species, endophytes, nitrogen fixing bacteria, methylotrophs, comammox (e.g., (COMplete AMMonia OXidation) an organism that can convert ammonia into nitrite and then into nitrate through the process of nitrification), phosphorus solubilizing, nitrite oxidizing, Nitrospira species, Methylobacterium species, and/or pink pigmented facultative methylotrophs (PPFM-trophs).

In some embodiments, a microorganism can be cultured and/or grown in a laboratory prior to protection. In some embodiments, a microorganism can be obtained from a natural source. In some embodiments, a microorganism can be concentrated prior to protection.

In some embodiments, a microorganism can be a spore/cyst forming microorganism. In some embodiments, a microorganism can be a spore/cyst forming bacteria. In some embodiments, a microorganism can be induced to form spores/cysts prior to and/or as part of a protection scheme. In some embodiments, a microorganism is not induced to form spores/cysts prior to and/or as part of a protection scheme. In some embodiments, a microorganism is not chemically induced to form spores/cysts prior to and/or as part of a protection scheme. In some embodiments, a protected microorganism has been selected for heat tolerance. In some embodiments, a protected microorganism as not been selected for heat tolerance.

### B. Methods of Protecting Microorganisms

As shown in FIG. 2 as a non-limiting example, a microbe-enhanced fertilizer (203) can comprise a microorganism (201) (e.g., a bacteria) that is protected (202) (e.g., protected by encapsulation, e.g., with calcium alginate) as described herein.

Prior to contacting with a fertilizer to obtain a microbe-enhanced fertilizer, microorganisms are protected. In some embodiments, microorganism protection may comprise any one or more of encapsulation, physical protection, and/or engineering methods. In some embodiments, microorganism protection is by contact with a protectant. In some instances, microorganism protection is by encapsulation in a protectant. In some embodiments, a protected microorganism is protected by addition of one or more physical protectants, engineering methods, encapsulating agents, water-soluble additives, stabilizer additives, and/or dispersants.

In some embodiments, microorganism protection can comprise encapsulation with a stabilizer protectant. In some embodiments, a stabilizer comprises one or more of clay, diatomaceous earth, starch, agar, alginate, chitosan, PEG, PVA, -polyacrylic acid, ethanol, humic acid, humates, talc, clay, peat, lignite, vermiculite, perlite and/or chemically modified versions of the same.

In some embodiments, chemical modification of a stabilizer can comprise, but is not limited to, one or more of esterification, alkylation, acetylation, phosphorylation, hydrophobic modification, sulfation, sulfomethylation, methylation, amidation, amination, protonation, halogenation, nitration, copolymerization, and/or physical or covalent cross-linking.

In some embodiments, a stabilizer comprises calcium alginate. In some embodiments, a stabilizer comprises sodium alginate. In some embodiments, a stabilizer comprises calcium alginate and sodium alginate.

In some embodiments, protection of a microorganism can also comprise addition of a water-soluble additive protectant. In some embodiments, a water soluble additive can be but is not limited to, glycerol, carboxy methyl cellulose (CMC), polyvinyl pyrrolidone (PVP), gum Arabic, guar gum, and/or mono and/or disaccharide based CMC/Arabic gum/guar gum.

In some embodiments, microorganism protection can comprise improved stickiness, stabilization and surfactant and dispersal abilities. In some embodiments, such characteristics can be provided by protectants/inducers and nutrients (e.g. Alginates/Glycerol/polyvinyl alcohol, PEG/PVP, Clay/humate, Mono and disaccharides, CMC/Arabic gum/guar gum).

In some embodiments, protection can comprise inclusion of certain stabilizers and/or additives at set proportions, including but not limited to 1:0.05, 1:0.10, 1:0.15, 1:0.20, 1:0.25, 1:0.30, 1:0.35, 1:0.40, 1:0.45, 1:0.50, 1:0.55, 1:0.60, 1:0.65, 1:0.70, 1:0.75, 1:0.80, 1:0.85, 1:0.90, 1:0.95, 1:1, 1:1.05, 1:1.10, 1:1.15, 1:1.20, 1:1.25, 1:1.30, 1:1.35, 1:1.40, 1:1.45, 1:1.5, 1:1.55, 1:1.60, 1:1.65, 1:1.70, 1:1.75, 1:1.80, 1:1.85, 1:1.90, 1:1.95, 1:2, 1:3, 1:4, 1:5, 1:10, 1:20, 1:30, 1:40, 1:50, 1:60, 1:70, 1:80, 1:90, 1:100, 1:1,000, 1:10,000, 1:100,000, 1:1,000,000, or any range derivable therein.

In some embodiments, microorganisms can be cultured and/or concentrated to greater than, or equal to, approximately 10⁴-10¹³ cells per mL prior to protection. In some embodiments, microorganisms can be cultured and/or concentrated to greater than, or equal to, approximately 10⁸-10⁹ cells per mL prior to protection.

In some embodiments, physical protection and/or engineering methods facilitate pelleting and/or layering of microorganisms as a liquid solution at the core or around a core of a fertilizer granule. In some embodiments, a bolus of concentrated microbes in a liquid carrier are protected with a soluble additive, such as a slurry of calcium carbonate, calcium alginate, and/or sodium alginate.

In some embodiments, physical protection of microorganisms may comprise encapsulation of microorganisms with calcium carbonate, calcium alginate, and/or sodium alginate. In some embodiments, physical protection of microorganisms consists essentially of encapsulation of microorganisms with calcium carbonate, calcium alginate, and/or sodium alginate. In some embodiments, physical protection or microorganisms may comprise the addition of protectants, such as but not limited to, diglycerol phosphate. In some embodiments, physical protection of microorganisms may comprise addition of protectants that are molecules and/or enzymes derived from thermophiles (e.g., heat tolerant bacteria), these molecules and/or enzymes may contribute to the thermo-protection phenotypes observed in thermophiles (see e.g., Pedro Lamosa et al., Thermostabilization of Proteins by Diglycerol Phosphate, a New Compatible Solute from Hyperthermophile Archaeoglobus fulgidus. Applied and Environmental Microbiology, Vol. 66, No. 5, 1 May 2000). In some embodiments, physical protection of microorganisms consists essentially of addition of protectants that are molecules and/or enzymes derived from thermophiles. Molecules and/or enzymes derived from thermophiles include proteins, lipids, saccharides, nucleic acids, small molecules, and/or inorganic compounds. In some embodiments, physical protection of microorganisms consists essentially of addition of diglycerol phosphate. Thermophiles may include bacteria, archaea, protists, and/or fungi. Thermophile microorganisms may include microorganisms that can thrive, divide, and/or survive at temperatures of 50° C. or greater. A non-limiting example of a thermophile is Archaeoglobus fulgidus.

In some embodiments, engineering methods for the protection of microorganisms may comprise spray drying and/or freeze-drying of the microorganisms. Freeze-drying can be performed by freezing the microorganisms or a composition containing the microorganisms, exposing the frozen microorganism or composition containing the microorganism to pressures below atmospheric pressures, and removing ice from or surrounding the frozen microorganism or composition. The composition containing the microorganism can contain, in some instances, a cryoprotectant, encapsulating agent, water-soluble additive, stabilizer additive, and/or a dispersant. In some embodiments, engineering methods for the protection of microorganisms consists essentially of spray drying and/or freeze-drying of the microorganisms.

In some embodiments, a microorganism is contacted with a protectant using a spray, liquid stream, semi-solid, or solid (such as a powder) comprising said protectant. In some embodiments, a protectant is contacted with a microorganism using a spray, liquid stream, semi-solid, or solid (such as a powder) comprising said microorganism.

In some embodiments, a protected microorganism is concentrated (e.g., settlement, centrifugation, affinity capture, selective growth media, etc.,) prior to contact with a protectant and/or prior to protecting. In some embodiments, a protected microorganism is contacted with the protectant or with the fertilizer at a concentration of higher than 10¹² cells per gram of the protectant. In some embodiments, a protectant is comprised in a liquid, suspension, and/or dried powder.

In some embodiments, a protected microorganism can contain low amounts of moisture. In some embodiments, a free-moisture content of a protected microorganism can be less than 0.6 wt. %, less than 0.5 wt. % water or 0.25 wt. % to less than 0.6 wt. % water. In some instances, the free moisture content is 0.5, 0.4, 0.3, 0.2, 0.1, or 0 wt. %.

In some embodiments, a protected microorganism can be comprised of one or more particles. In some embodiments, a first plurality of the particles can be a protectant, and a second plurality of the particles can be microorganism(s). In some instances, a particle can contain both protectant and a microorganism.

In certain non-limiting embodiments, particles can have an average particle size of 1, 2, 3, 4, 5, 6, 7, 8, 9, 10, 11, 12, 13, 14, 15, 20, 30, 40, 50, 60, 70, 80, 90, 100, 200, 300, 400, 500, 600, 700, 800, or 900 micrometers or any size there between. In some embodiments, particles can be elongated particles or can be substantially spherical particles or other shapes, or combinations of such shapes. Non-limiting examples of shapes include a sphere, a puck, an oval, a rod, an oblong, or a random shape. In some embodiments, a protected microorganism is a solid, powder, granule, liquid, gel, or semi-solid.

In some embodiments, 0.1 wt. % to 99.8 wt. % or 10 wt. % to 99.8 wt. % or at least one of, equal to any one of, or between any two 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95, 96, 97, 98, 99, 99.5, or 99.8 wt. % of a protected microorganism can be comprised of the protectant.

In some embodiments, a plurality of microorganisms are configured to be protected from having over 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99%, or greater than 99%, or any range derivable therein, of a plurality of microorganisms being killed when exposed to temperatures between 60 and 160° C. for at least 1, 2, 3, 4, 5, 6, 7, 8, 9, 10, 11, 12, 13, 14, 15, 16, 17, 18, 19, 20, or greater than 20 minutes, or any range derivable therein. In some embodiments, a plurality of microorganisms are configured to be protected from having over about 20%, 25%, 30%, 35%, 40%, 45%, 50%, 55%, 60%, 65%, 70%, 75%, 80%, 85%, 90%, or 95% of a plurality of microorganisms being killed when exposed to temperatures between 60 and 160° C. for at least 10 minutes.

### C. Methods of Making Fertilizers and Microbe-Enhanced Fertilizers

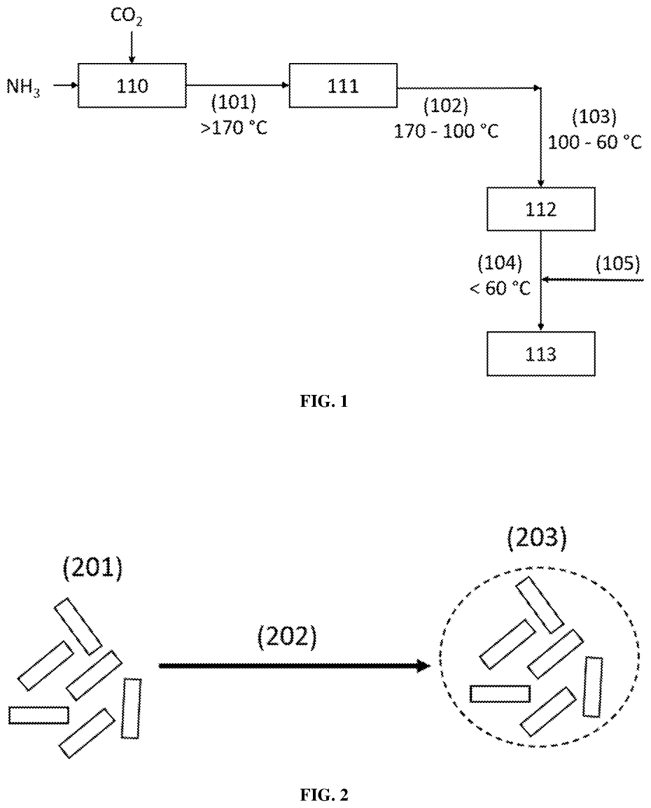

As shown in FIG. 1 as a non-limiting example, a fertilizer solution (e.g., urea solution) is created in a reactor (110). The fertilizer solution (101) (e.g., a fertilizer solution at temperatures >170° C.) can be transferred to an evaporator (111) to form a fertilizer melt (102). From the evaporator (111), a high temperature (e.g., <170 to 100° C.) fertilizer melt (102) can be cooled to a lower temperature (e.g., 60-100° C.) melt (103) and transferred to a granulator (112). The fertilizer melt can be granulated to form a solid microbe-enhanced fertilizer (113). As fertilizer temperatures decrease, case of microorganism protection from harsh environmental factors (e.g., heat and/or chemical stress) increases, but the homogeneity of the microbe-enhanced fertilizer may be decreased due to formation of larger fertilizer granules. Protected microorganisms can be introduced to at least at the noted integration points, for example at process steps where the temperatures are greater than 60° C., such as temperatures above 60° C. but lower than 170° C., or lower than 140° C. For example, the protected microorganisms can be introduced to the fertilizer solution after leaving the reactor (101), to the evaporator (111), to the fertilizer melt after leaving the evaporator (102), the fertilizer melt after it has cooled from the temperature found in the evaporated (102), the fertilizer solution after it has cooled from the temperature in the evaporator, to the granulator (112), to the fertilizer melt before being added to the granulator (103), etc. Following microorganism integration, microbe-enhanced fertilizers (104) can optionally be rapidly cooled to ambient temperatures (e.g., using air flow (105)). The resultant product is a microbe-enhanced fertilizer ((113) e.g., a bio-enhanced urea) comprising protected microorganisms, and a fertilizer (e.g., urea).

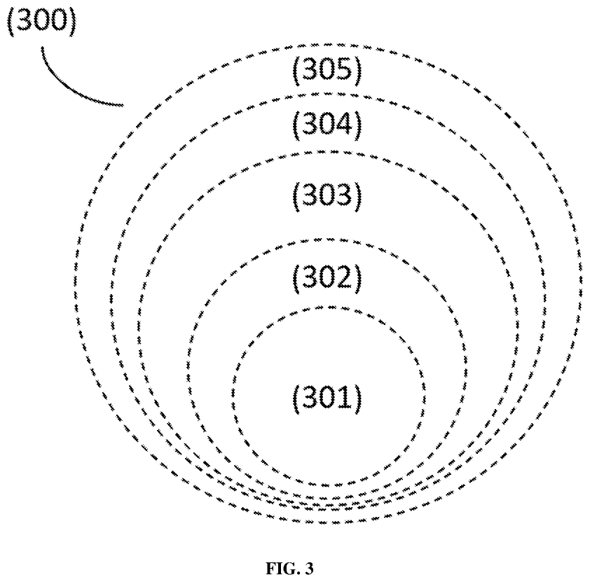

As shown in FIG. 3 as a non-limiting example, a microbe-enhanced fertilizer (300) can comprise a fertilizer (301) (e.g., as described herein, e.g., urea, DAP, NPK, etc.), comprised within a protected layer (302) (e.g., as described herein, e.g., oils/wax, humic acid, etc.), comprised within a microorganism culture layer (303) (e.g., comprising a microorganism described herein), comprised within an optional nutritional layer (304) (e.g., comprising sucrose, dextrose, trehalose, glycerol, starch, agar, etc.), comprising within an external protection layer (305) (e.g., comprising clays (e.g., bentonite), diatomaceous earth, polymers (e.g., alginate, chitosan, agar, etc.), etc.). In some embodiments, the core can be the protected microorganism (e.g., encapsulated microorganism or protective liquid containing microorganism) and can be surrounded by one or more layers of fertilizer, protective layer, or optional nutritional layer.

In some embodiments, microbe-enhanced fertilizers of the present disclosure comprise any granulatable fertilizer (e.g., granular fertilizer). In some embodiments, a microbe-enhanced fertilizer comprises one or more granular fertilizers, preferably but not limited to, one or more of urea, single super phosphate (SSP), triple super phosphate (TSP), ammonium sulfate, monoammonium phosphate (MAP), diammonium phosphate (DAP), muriate of potash (MOP), sulfate of potash (SOP), potassium sulfate, binary NP fertilizers, binary NK fertilizers, binary PK fertilizers, and/or a nitrogen phosphorus potassium (NPK) mix.

In some embodiments, fertilizer granulation comprises chemically reacting reactants to form the fertilizer. In some embodiments, the fertilizer is formed from or is provided in a solution. In some embodiments, the fertilizer is formed or is provided in a fertilizer melt. The fertilizer melt can be formed, in some instances by evaporating a fertilizer solution. In some instances, the fertilizer is formed from or is provided in a solidified fertilizer. The solidified fertilizer can be formed, in some instances by cooling a fertilizer melt. In some instances, the fertilizer is formed from or is provided in a granulated fertilizer. The granulated fertilizer can be formed, in some instances by granulating the solidified fertilizer melt or a cooling fertilizer melt.

As described herein, in some embodiments, a microbe-enhanced fertilizer is produced when a protected microorganism is contacted with the fertilizer before or during granulation.

In some embodiments, a fertilizer melt can be produced from substrates combined in a reactor. In some embodiments, a fertilizer solution can be concentrated in an evaporator. In some embodiments, a fertilizer solution can be concentrated to form a fertilizer melt with a concentration of 70, 75, 80, 85, 90, 95, 96, 97, 98, 99, 99.5, 99.8, 99.9, or any range derivable therein, weight percentage (wt. %) of the fertilizer. In some embodiments, a fertilizer melt can be dried and/or cooled in a dryer and/or cooler at a temperature of 35° C. to 100° C. or at least one of, equal to any one of, or between any two of 35° C., 40° C., 45° C., 50° C., 55° C., 60° C., 65° C. 70° C., 75° C., 80° C., 85° C., 90° C., 95° C. and 100° C. to form a solidified fertilizer melt and/or a fertilizer granule. Heat for drying can be provided by any means suitable or known. In some embodiments, an air stream is utilized to dry and/or cool a fertilizer melt.

In some embodiments, a fertilizer dryer can be heated by steam, such as in a steam jacketed dryer. In some embodiments, a fertilizer dryer can be or can be part of a rotating dryer. In some embodiments, a granulator can be separate from a dryer. In some embodiments, a dryer and granulator can be the same vessel or part of a same vessel. In some embodiments, a granulator, may include a rotatable section, a rotatable internal container, and/or a section that vibrates. In some embodiments, the rotatable section and/or rotatable internal container may contain internal flights and/or be rotated to induce movement of a fertilizer composition in the granulator. In some embodiments, a granulator can be or can be part of a granulation drum, pugmill, pan granulator, etc.

In some embodiments, water or an aqueous solution, such as steam and/or a scrubber solution, can be combined with a fertilizer composition in granulator to facilitate granulation of a fertilizer composition.

In some embodiments, a protected microorganism is contacted with a fertilizer by spraying onto a fertilizer particle and/or granule, by mixing into a fertilizer, by spraying a fertilizer onto the protected microorganism, by coating a fertilizer, by being coated by a fertilizer, by being encapsulated in a fertilizer matrix, by encapsulating a fertilizer to form a matrix of the protected microorganism, etc.

In some embodiments, a protected microorganism is contacted with a fertilizer when the fertilizer has a temperature in degrees Celsius (° C.) of 180, 179, 178, 177, 176, 175, 174, 173, 172, 171, 170, 169, 168, 167, 166, 165, 164, 163, 162, 161, 160, 159, 158, 157, 156, 155, 154, 153, 152, 151, 150, 149, 148, 147, 146, 145, 144, 143, 142, 141, 140, 139, 138, 137, 136, 135, 134, 133, 132, 131, 130, 129, 128, 127, 126, 125, 124, 123, 122, 121, 120, 119, 118, 117, 116, 115, 114, 113, 112, 111, 110, 109, 108, 107, 106, 105, 104, 103, 102, 101, 100, 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50 or any range derivable therein. In some embodiments, a protected microorganism is contacted with a fertilizer when the fertilizer has a temperature of equal to or more than about 60° C. In some embodiments, a protected microorganism is contacted with a fertilizer when the fertilizer has a temperature of about 60 to 160° C. In some embodiments, a protected microorganism is contacted with a fertilizer when the fertilizer has a temperature of about 80 to 100° C.

In some embodiments, a protected microorganism is contacted with a fertilizer using a spray, liquid stream, semi-solid, or solid (such as a powder) comprising said protected microorganism. In some embodiments, a protected microorganism is contacted with a fertilizer using a dosage pump or a spray head.

In some embodiments, a protected microorganism is concentrated (e.g., settlement, centrifugation, affinity capture, selective growth media, etc.,) prior to contact with a fertilizer to form a microbe-enhanced fertilizer. In some embodiments, a protected microorganism is contacted with the fertilizer at a concentration of 10⁴-10¹² cells per gram of the fertilizer. In some preferred embodiments, a protected microorganism is contacted with the fertilizer at a concentration of 10⁸-10⁹ cells per gram of the fertilizer. In some embodiments, a protected microorganism is comprised in a liquid, suspension, and/or dried powder.

In some embodiments, a microbe-enhanced fertilizer can contain low amounts of moisture. In some embodiments, a free-moisture content of a microbe-enhanced fertilizer can be less than 0.6 wt. %, less than 0.5 wt. % water or 0.25 wt. % to less than 0.6 wt. % water. In some instances, the free moisture content is 0.5, 0.4, 0.3, 0.2, 0.1, or 0 wt. %.

In some embodiments, a microbe-enhanced fertilizer can be comprised of one or more particles. In some embodiments, a first plurality of the particles can be a fertilizer, and a second plurality of the particles can be protected microorganism(s). In some instances, a particle can contain both fertilizer and a protected microorganism.

In certain non-limiting embodiments, particles can have an average particle size of 1, 2, 3, 4, 5, 6, 7, 8, 9, 10, 11, 12, 13, 14, 15, 20, 30, 40, 50, 60, 70, 80, 90, 100, 200, 300, 400, 500, 600, 700, 800, or 900 micrometers or any size there between. In some embodiments, particles can be elongated particles or can be substantially spherical particles or other shapes, or combinations of such shapes. Non-limiting examples of shapes include a sphere, a puck, an oval, a rod, an oblong, or a random shape. In some embodiments, a microbe-enhanced fertilizer is a powder, prill, and/or granule.

In some embodiments, 40 wt. % to 99.8 wt. % or 55 wt. % to 99.8 wt. % or at least one of, equal to any one of, or between any two 40, 45, 50, 55, 60, 65, 70, 75, 80, 85, 90, 95, 96, 97, 98, 99, 99.5, or 99.8 wt. % of a microbe-enhanced fertilizer can be comprised of the fertilizer product.

In some embodiments, a microbe-enhanced fertilizer particle can have a crush strength of 1, 2, 3, 4, 5, 6, 7, 8, 9, 10 kgf/particle, or more, or any amount there between, preferably 2 kgf/particle to 5 kgf/particle.

In some embodiments, a microbe-enhanced fertilizer can contain a coating on the surface of one or more particles. In some instances, the coating can include nutrients for a plant, inhibitors of urea hydrolysis and/or nitrification, agents to slow or increase the rate of degradation of the granule and/or fertilizers, agents to repel moisture and/or provide a hydrophobic layer, agents that decrease or increase the reactivity of the granule and/or fertilizers, agents that provide additional benefits to plants, agents that increase the stability and/or crush strength of the granule and/or fertilizers, pH buffering agents, drying agents, etc. or any combination thereof. The coating can be a commercially available coating, an oil, a fertilizer, a micronutrient, talc, a seaweed and/or seaweed extract, a wax, etc. In some instances, the coating can contain surfactants. In some instances, the coating contains a wax, surfactants, and/or an amine-based compound.

### D. Methods of Using Microbe-Enhanced Fertilizers

In some embodiments, microbe-enhanced fertilizer compositions of the present disclosure can be used in methods of increasing the amount of one or more nutrients and one or more microorganisms in soil, and of enhancing plant growth. In some embodiments, methods can include applying to the soil an effective amount of a composition microbe-enhanced fertilizers of the present disclosure. In some embodiments, methods may include increasing the growth and yield of crops, trees, ornamentals, etc. such as, for example, palm, coconut, rice, wheat, corn, barley, oats, and soybeans. In some embodiments, methods can include applying microbe-enhanced fertilizer of the present disclosure to at least one of a soil, an organism, a liquid carrier, a liquid solvent, etc (e.g., a target substrate).

In some embodiments, a microbe-enhanced fertilizer can be stored. In some embodiments, the microbe-enhanced fertilizer can be stored for any amount of time, such as 1 minute, 10 minutes, 30 minutes, 1 hour, 2 hours, 4 hours, 8 hours, 12 hours, 16 hours, 1 day, 2 days, 5 days, 1 week, 2 weeks, 3 weeks, 4 weeks, 1 month, 2 months, 3 months, 4 months, 5 months, 6 months, 1 year, 2 years, 3 years, 4 years, 5 years or more, or any amount of time or range thereof or there between without 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70. 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% of the microorganisms in the micro-enhanced fertilizer dying. In some embodiments, the microorganisms and/or fertilizer components of the microbe-enhanced fertilizer composition have an extended shelf life relative to microbe-enhanced fertilizers created through traditional methods.

In some embodiments, once a microbe-enhanced fertilizer is applied to a target substrate, microorganism protection materials degrade under field conditions and release the protected microorganisms to deliver their bio-effects.

Non-limiting examples of plants that can benefit from the microbe-enhanced fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes. The Gymnosperms may include plants from the Araucariaceae, Cupressaceae, Pinaceae, Podocarpaceae, Sciadopitaceae, Taxaceae, Cycadaceae, and Ginkgoaceae families. The Angiosperms may include plants from the Aceraceae, Agavaceae, Anacardiaceae, Annonaceae, Apocynaceae, Aquifoliaceae, Araliaceae, Arecaceae, Asphodelaceae, Asteraceae, Berberidaceae, Betulaceae, Bignoniaceae, Bombacaceae, Boraginaceae, Burseraceae, Buxaceae, Canellaceae, Cannabaceae, Capparidaceae, Caprifoliaceae, Caricaceae, Casuarinaceae, Celastraceae, Cercidiphyllaceae, Chrysobalanaceae, Clusiaceae, Combretaceae, Cornaceae, Cyrillaceae, Davidsoniaceae, Ebenaceae, Elaeagnaceae, Ericaceae, Euphorbiaceae, Fabaceae, Fagaceae, Grossulariaceae, Hamamelidaceae, Hippocastanaceae, Illiciaceae, Juglandaceae, Lauraceae, Lecythidaceae, Lythraceae, Magnoliaceae, Malpighiaceae, Malvaceae, Melastomataceae, Meliaceae, Moraceae, Moringaceae, Muntingiaceae, Myoporaceae, Myricaceae, Myrsinaceae, Myrtaceae, Nothofagaceae, Nyctaginaceae, Nyssaceae, Olacaceae, Oleaceae, Oxalidaceae, Pandanaceae, Papaveraceae, Phyllanthaceae, Pittosporaceae, Platanaceae, Poaceae, Polygonaceae, Proteaceae, Punicaceae, Rhamnaceae, Rhizophoraceae, Rosaceae, Rubiaceae, Rutaceae, Salicaceae, Sapindaceae, Sapotaceae, Simaroubaceae, Solanaceae, Staphyleaceae, Sterculiaceae, Strelitziaceae, Styracaceae, Surianaceae, Symplocaceae, Tamaricaceae, Theaceae, Theophrastaceae, Thymelaeaceae, Tiliaceae, Ulmaceae, Verbenaceae, and/or Vitaceae family.

In some embodiments, the effectiveness of compositions comprising microbe-enhanced fertilizers of the present invention can be ascertained by measuring the amount of particular nutrients in the soil at various times after applying the microbe-enhanced fertilizer composition to the soil. In some embodiments, the effectiveness of compositions comprising microbe-enhanced fertilizers of the present invention can be ascertained by measuring the amount of the microorganism in the soil at various times after applying the microbe-enhanced fertilizer composition to the soil. It is understood that different soils have different characteristics, which can affect the stability nutrients and microorganisms in the soil. In some embodiments, effectiveness of a microbe-enhanced fertilizer composition can be directly compared to other fertilizer compositions by doing a side-by-side comparison in the same soil under the same conditions.

In some embodiments, microbe-enhanced fertilizers according to the present disclosure can have a density that is greater than water. This can allow the granules and/or fertilizers to sink in water rather than float. This can be especially beneficial in instances where application is intended to a crop that is at least partially or fully submerged in water. A non-limiting example of such a crop is rice, as the ground in a rice paddy is typically submerged in water. Thus, application of microbe-enhanced fertilizers to such crops can be performed such that the granules and/or fertilizer are homogenously distributed on the ground that is submerged under water.

### E. Compositions Comprising Microbe-Enhanced Fertilizers and Characteristics Thereof

In some embodiments, microbe-enhanced fertilizers of the present disclosure can also be included in a blended or compounded fertilizer composition comprising other fertilizers, such as other fertilizer granules. Additional fertilizers can be chosen based on the particular needs of certain types of soil, climate, or other growing conditions to maximize the efficacy of the microbe-enhanced fertilizer in enhancing plant growth and crop yield. The other fertilizer granules can be granules of urea, single super phosphate (SSP), triple super phosphate (TSP), ammonium sulfate, monoammonium phosphate (MAP), diammonium phosphate (DAP), muriate of potash (MOP), and/or sulfate of potash (SOP), and the like.

In some embodiments, microbe-enhanced fertilizers described herein can be used alone or in combination with other fertilizer actives and micronutrients. In some embodiments, the other fertilizer actives and micronutrients can be added with any of the ingredients at the beginning of the drying stage or granulation process or at any later stage.

Non-limiting examples of additional additives can be micronutrients, primary nutrients, and secondary nutrients. A micronutrient is a botanically acceptable form of an inorganic or organometallic compound such as boron, copper, iron, chloride, manganese, molybdenum, nickel, or zinc. A primary nutrient is a material that can deliver nitrogen, phosphorous, and/or potassium to a plant. Nitrogen-containing primary nutrients may include urea, ammonium nitrate, ammonium sulfate, diammonium phosphate, monoammonium phosphate, urea-formaldehyde, or combinations thereof. A secondary nutrient is a substance that can deliver calcium, magnesium, and/or sulfur to a plant. Secondary nutrients may include lime, gypsum, superphosphate, or a combination thereof. For example, in some instances the microbe-enhanced fertilizer composition can contain calcium sulfate, potassium sulfate, magnesium sulfate or a combination thereof.

In some embodiments, microbe-enhanced fertilizer compositions of the present disclosure can comprise one or more inhibitors. In some embodiments, an inhibitor can be a urease inhibitor or a nitrification inhibitor, or a combination thereof. In some embodiments, a urease inhibitor and a nitrification inhibitor are included. In some embodiments, an inhibitor can be a urease inhibitor. Suitable urease inhibitors include, but are not limited to, N-(n-butyl) thiophosphoric triamide (NBTPT) and phenylphosphorodiamidate (PPDA). In some embodiments, a microbe-enhanced fertilizer composition can comprise NBTPT or PPDA, or a combination thereof. In some embodiments, an inhibitor can be a nitrification inhibitor. Suitable nitrification inhibitors include, but are not limited to, 3,4-dimethylpyrazole phosphate (DMPP), dicyandiamide (DCD), thiourea (TU), 2-chloro-6-(trichloromethyl)-pyridine (Nitrapyrin), 5-ethoxy-3-trichloromethyl-1,2,4-thiadiazol, which is sold under the tradename Terrazole®, by OHP Inc., USA, 2-amino 4-chloro 6-methyl pyrimidine (AM), 2-mercaptobenzothiazole (MBT), or 2-sulfanilamidothiazole (ST), and any combination thereof. In some embodiments, a nitrification inhibitor can comprise DMPP, DCD, TU, nitrapyrin, 5-ethoxy-3-trichloromethyl-1,2,4-thiadiazol, AM, MBT, or ST, or a combination thereof. In some embodiments, a microbe-enhanced fertilizer composition can comprise NBTPT, DMPP, TU, DCD, PPDA, nitrapyrin, 5-ethoxy-3-trichloromethyl-1,2,4-thiadiazol, AM, MBT, ST, or a combination thereof.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results

### Example 1

Protected microorganisms are added to a fertilizer solution preparation at temperatures of about 60-80° C., 80-100° C., 100-120° C., and/or 120-140° C. Different doses (colony forming units, CFU) are added (e.g., 3 to 5 different doses). After granulation, samples are taken for accelerated stability assessment to predict fertilizer and/or microorganism shelf life. Empirical data is correlated with predicted data.

1. A method of making a microbe-enhanced fertilizer composition, the method comprising: combining a protected microorganism with a fertilizer prior to and/or during fertilizer granulation to obtain the composition, wherein the protected microorganism contacts the fertilizer when the fertilizer has a temperature greater than 60° C.

2. The method of claim 1, wherein the temperature is 60 to 160° C.

3. The method of claim 1, wherein the protected microorganism is homogenously mixed into the fertilizer.

4. The method of claim 1, further comprising cooling the obtained composition to a temperature below 60° C.

5. The method of claim 1, wherein the fertilizer comprises one or more granular fertilizer.

6. The method of claim 1, wherein fertilizer granulation comprises chemically reacting reactants to form the fertilizer in a solution, forming a fertilizer melt from the solution, solidifying the fertilizer melt, and granulating the solidified fertilizer melt, and wherein the protected microorganism is contacted with the fertilizer before or during granulation.

7. The method of claim 1, wherein the protected microorganism is protected by addition of one or more physical protectants, engineering methods, encapsulating agents, water-soluble additives, stabilizer additives, and/or dispersants.

8. The method of claim 1, wherein the protected microorganism is encapsulated with a stabilizer.

9. The method of claim 8, wherein the stabilizer comprises one or more of clay, diatomaceous earth, starch, agar, alginate, chitosan, PEG, PVA, -polyacrylic acid, ethanol, humic acid, humates, talc, clay, peat, lignite, vermiculite, perlite and/or chemically modified versions of the same.

10. The method of claim 7, wherein the water-soluble additive comprises glycerol, carboxy methyl cellulose (CMC), polyvinyl pyrrolidone (PVP), gum Arabic, guar gum, and/or mono and/or disaccharide based CMC/Arabic gum/guar gum.

11. The method of claim 7, wherein the physical protectant is a molecule and/or enzyme derived from a thermophilic organism.

12. The method of claim 7, wherein the engineering method comprises spray drying, and/or freeze-drying.

13. The method of claim 1, wherein the protected microorganism comprises a spore/cyst forming bacteria, wherein the microorganism protected has not been chemically induced to form spores/cysts, wherein the protected microorganism has not been selected for heat tolerance, and/or wherein the protected microorganism is not comprised in a chemically induced spore or cyst when contacted with the fertilizer.

14. The method of claim 1, wherein the protected microorganism comprises diazotrophic bacteria, Azospirillum species, Azotobacter species, Frateuria aurantia, Bacillus species, endophytes, nitrogen fixing bacteria, methylotrophs, comammox, phosphorus solubilizing, nitrite oxidizing, Nitrospira species, Methylobacterium species, and/or pink pigmented facultative methylotrophs (PPFM-trophs).

15. A microbe-enhanced fertilizer produced by the method of claim 1.

16. A microbe-enhanced fertilizer composition comprising:
a plurality of microorganisms configured to be protected from having over 50% of the plurality of microorganisms being killed when exposed to temperatures between 60 and 160° C. for at least 10 minutes; and
a fertilizer contacting the protected microorganism,
wherein the protected microorganism is at least partially surrounded by the fertilizer.

17. The microbe-enhanced fertilizer composition of claim 16, wherein at least 90% of the plurality of microorganisms are not comprised in a spore or a cyst, wherein the plurality of microorganisms comprise a spore/cyst forming bacteria, and/or wherein the plurality of microorganisms have not been selected for heat tolerance within 1 week of being contacted with the fertilizer.

18. The microbe-enhanced fertilizer composition of claim 16, wherein the fertilizer is a solidified fertilizer melt.

19. The microbe-enhanced fertilizer composition of claim 16, wherein the fertilizer contacting the protected plurality of microorganisms is a solidified fertilizer melt that at least partially coats the protected plurality of microorganisms and/or wherein solidified fertilizer melt is in the form of a continuous matrix that encapsulates the protected plurality of microorganisms.

20. The microbe-enhanced fertilizer composition of claim 16, wherein the fertilizer comprises one or more granular fertilizer.
